(19) United States
(12) Patent Application Publication
(10) Pub. No.: US 2026/0005474 A1
(43) Pub. Date: Jan. 1, 2026

(54) ORIENTATION AGNOSTIC ELECTRONIC DEVICE MODULES

(71) Applicant: VIRGIN GALACTIC HOLDINGS, INC., Tustin, CA (US)

(72) Inventor: Balkar Sidhu, San Jose, CA (US)

(21) Appl. No.: 18/759,598

(22) Filed: Jun. 28, 2024

(51) Int. Cl. H01R 13/64; H01R 13/66; H01R 27/00

(52) U.S. Cl. CPC H01R 13/64; H01R 13/6641; H01R 27/00

(57) ABSTRACT

Examples of the presently disclosed technology provide electronic device modules which can promote fail-safe installation for polarity-dependent circuit elements, and other electronic circuit elements. In some implementations, the electronic device modules may be orientation agnostic about one or more axes.

### TECHNICAL FIELD

The present disclosure relates generally to electronic devices. In particular, some implementations may relate to orientation agnostic electronic device modules.

### DESCRIPTION OF RELATED ART

Certain electronic circuit elements may be configured to allow electrical current to flow in a first direction, while restricting electrical current from flowing in a second direction contrary to the first direction. Such electronic circuit elements may be referred to herein as “polarity-dependent” circuit elements.

A diode is one example of a polarity-dependent circuit element. As used herein, a diode may refer to a two-terminal semiconductor device which conducts and allows the flow of electrical current primarily in a first direction, while restricting electrical current from flowing in a second direction contrary to the first direction.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates an example electronic device module, in accordance with various examples of the presently disclosed technology.

FIG. 2 illustrates the example electronic device module from FIG. 1 and two external connectors mechanically and electrically connected in a first orientation, in accordance with various examples of the presently disclosed technology.

FIG. 3 illustrates the example electronic device module and the two external connectors from FIG. 2 mechanically and electrically connected in a second orientation, in accordance with various examples of the presently disclosed technology.

FIG. 4 illustrates how the example electronic device module and the two external connectors from FIG. 2 may be restricted/prevented from mechanical and electrical connection in a third orientation, in accordance with various examples of the presently disclosed technology.

FIG. 5 illustrates an example electronic device module system in a first orientation, in accordance with various examples of the presently disclosed technology.

FIG. 6 illustrates the example electronic device module system from FIG. 5 in a second orientation, in accordance with various examples of the presently disclosed technology.

The figures are not exhaustive and do not limit the present disclosure to the precise form disclosed.

### DETAILED DESCRIPTION

As described above, certain electronic circuit elements (e.g., diodes) may be configured to allow electrical current to flow in a first direction, while restricting electrical current from flowing in a second direction contrary to the first direction. Such electronic circuit elements may be referred to herein as “polarity-dependent” circuit elements.

Polarity-dependent circuit elements (e.g., diodes) may be used in various applications. For example, polarity-dependent circuit elements may be used to protect against back electromotive force (EMF) from electronic valves, solenoids and relays. Polarity-dependent circuit elements may also be used for isolating power and signals when terminating to multiple sources/destinations.

A problem with conventional polarity-dependent circuit elements is that if they are installed with an improper mechanical orientation (e.g., flipped 180 degrees in the wrong direction), they may not operate as intended. Namely, installing a polarity-dependent circuit element in an improper mechanical orientation may correspond with the polarity-dependent circuit element having an improper polarity orientation (e.g., permitting vs. restricting electrical current in the wrong directions) in a circuit. Here, improper polarity orientation for the polarity-dependent circuit element within the circuit may render the circuit inoperative, or otherwise cause latent issues which are only observed when a system the circuit is implemented in is operating. This can be a problem when, e.g., the circuit is part of a mission critical system and latent issues caused by improper installation of the polarity-dependent electronic circuit are only detected during operation of the mission-critical system.

Installation of conventional polarity-dependent circuit elements in improper orientations is more common than desirable because in many cases, improper vs. proper orientation for a conventional polarity-dependent circuit element may be visually similar or identical. Relatedly, many common (so called “off-the-shelf”) electrical connectors will typically permit mechanical installation of a polarity-dependent circuit element in an improper orientation. Again, this can be a problem when the polarity-dependent circuit element is improperly installed in a mission-critical system, and the improper installation causes latent issues which are only observed during operation of the mission-critical system.

Against this backdrop, examples of the presently disclosed technology provide electronic device modules which can facilitate fail-safe installation for polarity-dependent circuit elements, and other electronic circuit elements.

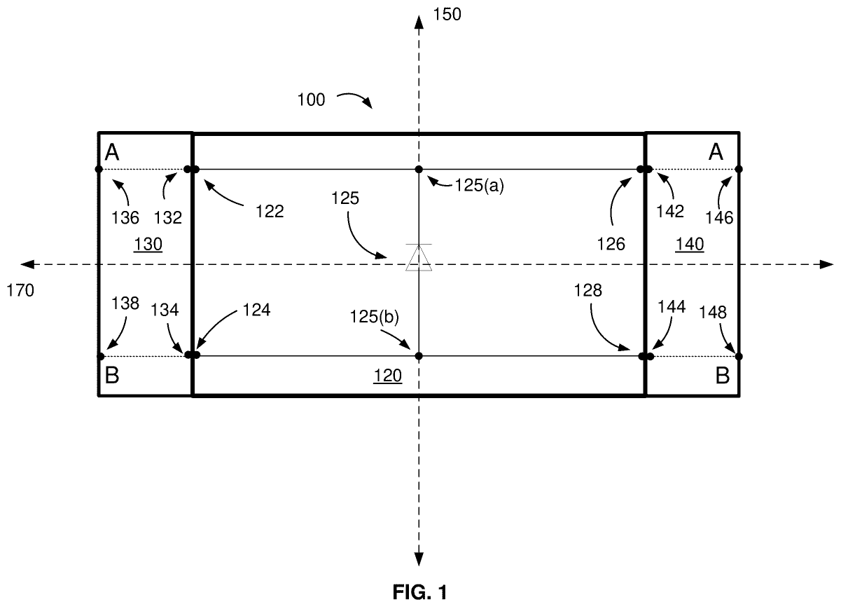

As described below in conjunction with FIGS. 1-4 below, a first example electronic device module may be “orientation agnostic” when rotated about a first axis. Accordingly, an electronic circuit element installed within the first example electronic device module may operate as intended when installed in two different orientations rotated 180 degrees from each other about the first axis. By contrast, the first example electronic device module may be configured to mechanically restrict/prevent improper installation when the first example electronic device module is rotated 180 degrees about a second axis orthogonal to the first axis. For example, external connector-facing interfaces of the first example electronic device module may be keyed to permit mechanical (and electrical) connection in a first orientation with respect to external connectors, while restricting/preventing mechanical (and electrical) connection to the external connectors when the first example electronic device module is rotated 180 degrees about the second axis. Here, rotation about the second axis may correspond with flipping the polarity of a polarity-dependent circuit element in the first example electronic device module. Accordingly, leveraging a configuration which mechanically prevents/restricts the first example electronic device module from being installed in an improper polarity orientation, the first example electronic device module can improve safety and fail-safe operation for circuits/systems the first example electronic device module is installed within. Moreover, the first example electronic device module may be used in conjunction with many common (so called “off-the-shelf” electrical connectors, such as “off-the-shelf” keyed electrical connectors), which may provide an advantage over potential alternative designs.

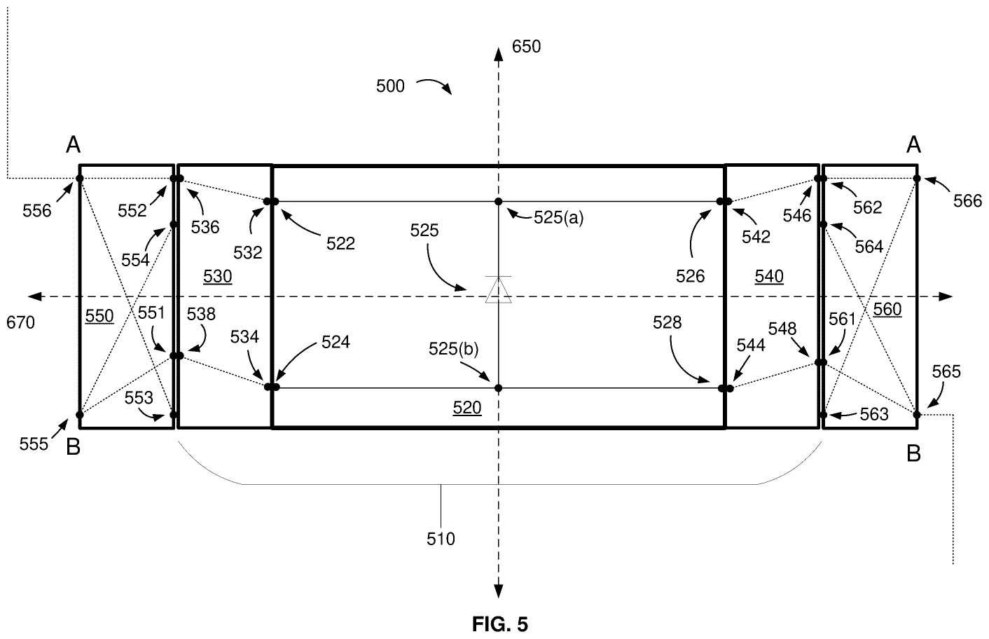

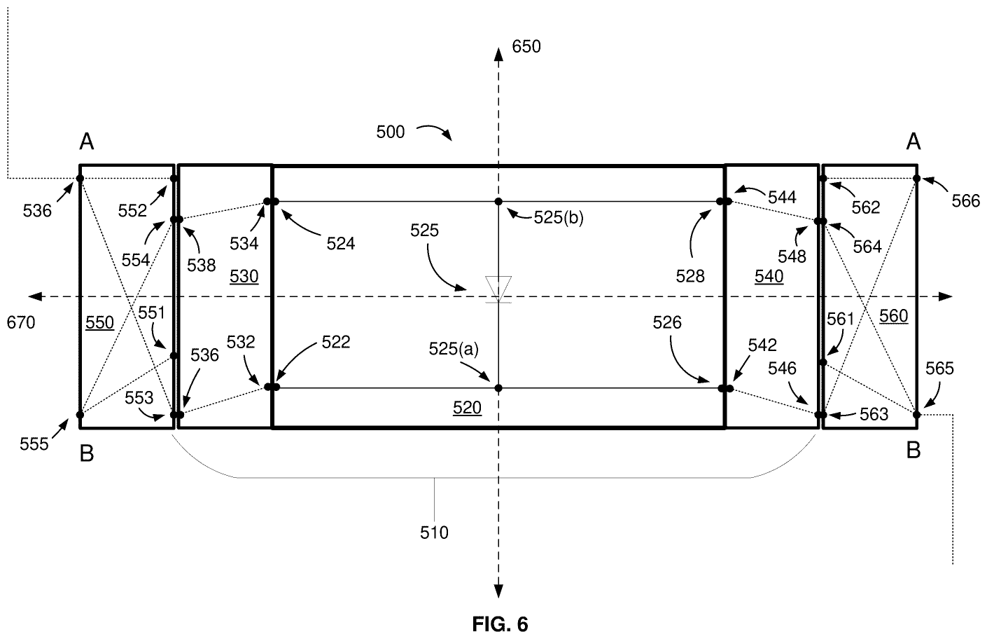

As described below in conjunction with FIGS. 5-6 below, a system comprising a second example electronic device module and two specialized external connectors, may be “orientation agnostic” when the second example electronic device module is rotated about both a first axis and a second axis orthogonal to the first axis. Accordingly, a polarity-dependent electrical circuit element installed within the second example electronic device module may operate properly when the second example electronic device module is installed in any orientation.

Examples of the presently disclosed technology are described in greater detail in conjunction with the following FIGs.

FIG. 1 illustrates an example electronic device module 100, in accordance with various examples of the presently disclosed technology.

As depicted, electronic device module 100 comprises an electronic device 120, a first connector module 130, and a second connector module 140. As depicted, electronic device 120, first connector module 130, and second connector module 140 may be arranged along an axis 170 such that electronic device 120 is positioned between first connector module 130 and second connector module 140 along axis 170.

As described above (and as described in greater detail below), external connector-facing interfaces of electronic device module 100 may be symmetric about an axis 150 orthogonal to axis 170. In other words, electronic device module 100 may be “orientation agnostic” about axis 150. By contrast, the external connector-facing interfaces of electronic device module 100 may be asymmetric (e.g., through keying of the external connector-facing interfaces of electronic device module 100) about axis 170. Here, rotation about axis 170 may correspond with flipping a polarity orientation of electronic device module 100 when electronic device module 100 comprises a polarity-dependent circuit element (e.g., a diode).

Accordingly, electronic device module 100 may be configured to permit installation when electronic device module 100 is rotated about axis 150, while restricting/preventing installation with an improper polarity orientation corresponding to a rotation about axis 170.

Referring again to FIG. 1, as depicted, electronic device 120 may comprise a two-terminal circuit element 125, having a first terminal 125(a) and a second terminal 125(b). First terminal 125(a) may be at a first voltage and terminal 125(b) may be at a second voltage. In certain implementations, two-terminal circuit element 125 may comprise a polarity-dependent circuit element, such as a diode.

As depicted, electronic device 120 may further comprise four connector module-facing contacts. Namely, a connector module-facing contact 122 and a connector module-facing contact 126 may be electrically connected to first terminal 125(a) of two-terminal circuit element 125. Accordingly, connector module-facing contact 122 and connector module-facing contact 126 may be at the first voltage. A connector module-facing contact 124 and a connector module-facing contact 128 may be electrically connected to second terminal 125(b) of two-terminal circuit element 125. Accordingly, connector module-facing terminal 124 and connector module-facing terminal 128 may be at the second voltage.

As depicted, first connector module 130 may comprise two electronic device-facing contacts. Namely, an electronic device-facing contact 132 may mechanically and/or electrically connect to connector module-facing contact 122. Likewise, an electronic device-facing contact 134 may mechanically and/or electrically connect to connector module-facing contact 124.

Like first connector module 130, second connector module 140 may comprise two electronic device-facing contacts. Namely, an electronic device-facing contact 142 may mechanically and electrically connect to connector module-facing terminal 126. Likewise, an electronic device-facing contact 144 may mechanically and electrically connect to connector module-facing contact 128.

Here, electronic device-facing contacts 132, 134, 142, and 144 may comprise various types of electrical contacts.

As depicted, first connector module 130 may further comprise two external connector-facing contacts. Namely, an external connector-facing contact 136 may be electrically connected to electronic device-facing contact 132. Similarly, an external connector-facing contact 138 may be electrically connected to electronic device-facing contact 134.

Like first connector module 130, second connector module 140 may also further comprise two external connector-facing contacts. Namely, an external connector-facing contact 146 may be electrically connected to electronic device-facing contact 142. Similarly, an external connector-facing contact 148 may be electrically connected to electronic device-facing contact 144.

Here, external connector-facing contacts 136, 138, 146, and 148 may comprise various types of electrical contacts.

As described above, in certain implementations external connector-facing interfaces of first connector module 130 and second connector module 140 may be keyed to permit mechanical/electrical connection when electronic device module 100 is rotated about axis 150, while restricting/preventing mechanical/electrical connection when electronic device module 100 is rotated about axis 170. Accordingly, in implementations where two-terminal circuit element 125 is a polarity-dependent circuit element (e.g., a diode), such keying can prevent installation in an improper polarity orientation.

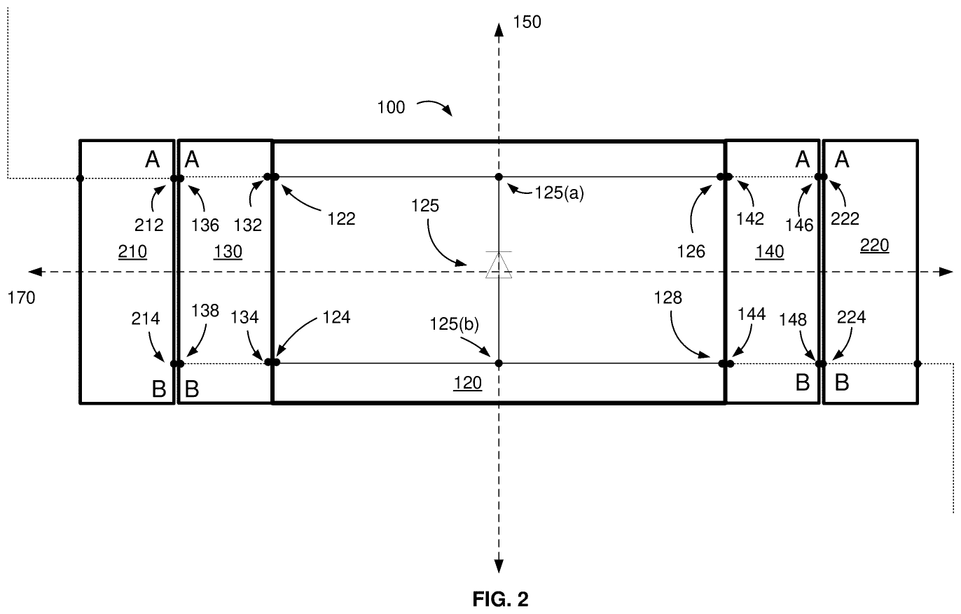

The functionality described above is illustrated and described in conjunction with FIGS. 2-4 below.

As depicted, in FIG. 2, electronic device module 100 has the same orientation as in FIG. 1. This orientation may correspond with a proper polarity orientation for electronic device module 100 in FIGS. 2-4.

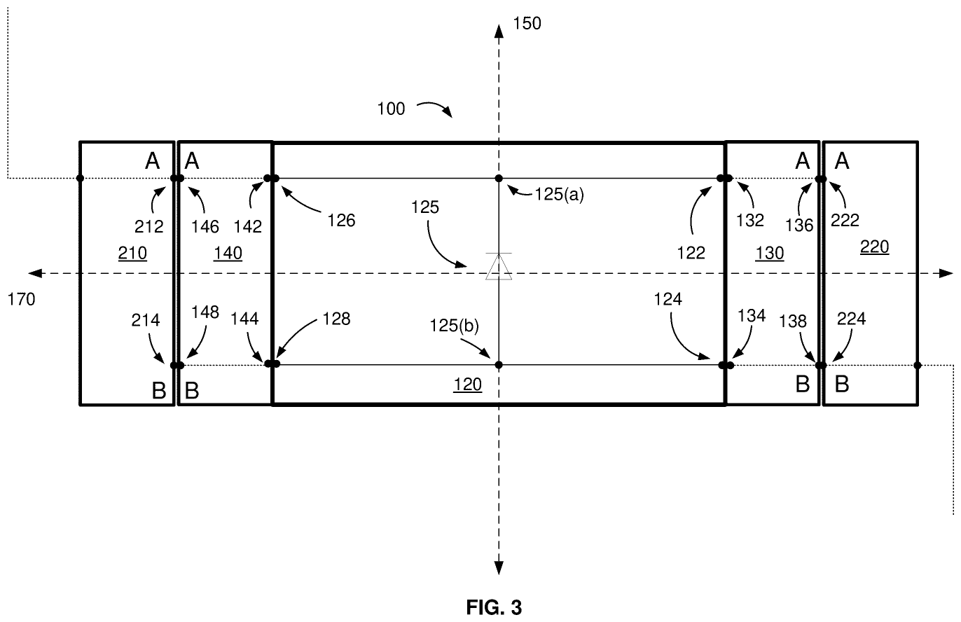

In FIG. 3, the orientation of electronic device module 100 has been rotated 180 degrees about axis 150. This orientation may still correspond with a proper polarity orientation for electronic device module 100 in FIGS. 2-4.

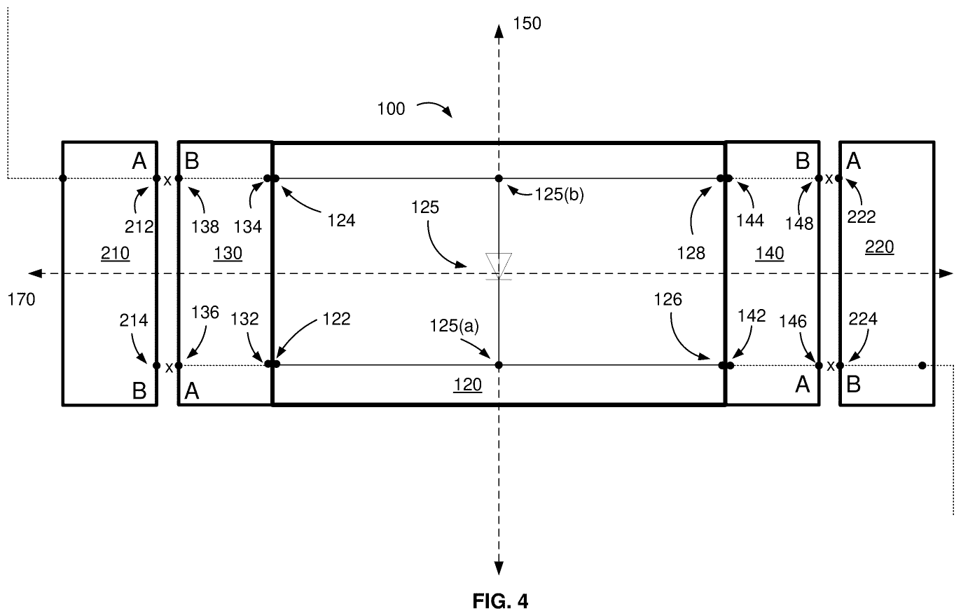

In FIG. 4, the orientation of orientation agnostic electronic device module 100 has been rotated 180 degrees about axis 170. This orientation may correspond with an improper polarity orientation for electronic device module 100 in FIGS. 2-4.

As depicted in FIGS. 2 and 3, electronic device module 100 may be mechanically and electrically connected to external connector 210 (on the left side of FIGS. 2 and 3) and external connector 220 (on the right side of FIGS. 2 and 3) when electronic device module 100 is in a proper polarity orientation. In certain implementations, electronic device module 100 and external connectors 210 and 220 may be arranged/installed in a printed circuit board (PCB). In other implementations, external connectors 210 and 220 may comprise connectors for two respective wiring harnesses.

As alluded to above, external connector-facing interfaces of first connector module 130 and second connector module 140 may be keyed such that mechanical connection to external connectors 210 and 220 is permitted in the proper polarity orientations depicted in FIGS. 2 and 3. By contrast, such keying may restrict/prevent mechanical connection to external connectors 210 and 220 in the improper polarity orientation depicted in FIG. 4.

For example, in the proper polarity orientation depicted in FIG. 2, external connector-facing contact 136 may mechanically and/or electrically connect to contact 212 of external connector 210. Likewise, external connector-facing contact 138 may mechanically and/or electrically connect to contact 214 of external connector 210. Similarly, external connector-facing contact 146 may mechanically and/or electrically connect to contact 222 of external connector 220. Likewise, external connector-facing contact 148 may mechanically and/or electrically connect to contact 224 of external connector 210.

Similarly, in the proper polarity orientation depicted in FIG. 3 (i.e., comprising a 180 degree rotation about axis 150 from FIG. 2), external connector-facing contact 136 may now mechanically and/or electrically connect to contact 222 of external connector 220. Likewise, external connector-facing contact 138 may now mechanically and/or electrically connect to contact 224 of external connector 22. Similarly, external connector-facing contact 146 may now mechanically and/or electrically connect to contact 212 of external connector 210. Likewise, external connector-facing contact 148 may mechanically and/or electrically connect to contact 214 of external connector 210.

However, in the improper polarity orientation depicted in FIG. 4 (i.e., comprising a 180 degree rotation about axis 170 from FIG. 2), the keying of external connector-facing interfaces of first connector module 130 and second connector module 140 may restrict/prevent mechanical and electrical between electronic device module 100 and external connectors 210 and 220. Accordingly, such keying may restrict/prevent electronic device module 100 from being installed with improper polarity.

FIG. 5 illustrates an example electronic device module system 500 in a first orientation, in accordance with various examples of the presently disclosed technology.

FIG. 6 illustrates the example electronic device module system 500 in a second orientation, in accordance with various examples of the presently disclosed technology.

As described above, electronic device module system 500 comprising an electronic device module 510 and two specialized external connectors 550 and 560, may be “orientation agnostic” when electronic device module 510 is rotated about both an axis 650 and an axis 670 orthogonal to axis 650. Accordingly, a polarity-dependent electrical circuit element (e.g., two-terminal circuit element 525) installed within electronic device module 510 may operate properly when electronic device module 510 is installed in any orientation.

As depicted in FIGS. 5-6, electronic device module system 500 may comprise an electronic device module 510, an external connector 550, and an external connector 560. When the components of electronic device module system 500 are mechanically and electrically connected to each other, electronic device module 510, external connector 550, and external connector 560 may be arranged along the axis 670 such that electronic device module 510 is positioned between external connector 550 and external connector 560 along axis 670.

As depicted, electronic device module 510 comprises an electronic device 520, a first connector module 530, and a second connector module 540. As depicted, electronic device 520, first connector module 530, and second connector module 540 may be arranged along axis 670 such that electronic device 520 is positioned between first connector module 530 and second connector module 540 along axis 670.

Like electronic device module 100, external connector-facing interfaces of electronic device module 510 may be symmetric about axis 650 (which is orthogonal to axis 670). In other words, electronic device module 510 may be “orientation agnostic” about axis 650.

As described below, the combination of electronic device module 510 and external connectors 550 and 560 may make electronic device module system 500 “orientation agnostic” about axis 670 as well. This may be the case even where electronic device module 510 comprises a polarity-dependent circuit component—and rotation about axis 670 corresponds with a switch of polarity orientation for electronic device module 510. As depicted in FIGS. 5-6, such orientation agnosticism about axis 670 can be realized due to a combination of: (1) strategic spacing/positioning of external connector-facing contacts for electronic device module 510; (2) strategic spacing/positioning of electronic device module-facing contacts for external connectors 550 and 560; and (3) strategic electrical routing through external connectors 550 and 560.

Referring again to FIG. 5, as depicted, electronic device 520 may comprise a two-terminal circuit element 525, having a first terminal 525(a) and a second terminal 525(b). First terminal 525(a) may be at a first voltage and terminal 525(b) may be at a second voltage. In certain implementations, two-terminal circuit element 525 may comprise a polarity-dependent circuit element, such as a diode.

As depicted, electronic device 520 may further comprise four connector module-facing contacts. Namely, a connector module-facing contact 522 and a connector module-facing contact 526 may be electrically connected to first terminal 525(a) of two-terminal circuit element 525. Accordingly, connector module-facing contact 522 and connector module-facing contact 526 may be at the first voltage. A connector module-facing contact 524 and a connector module-facing contact 528 may be electrically connected to second terminal 525(b) of two-terminal circuit element 525. Accordingly, connector module-facing contact 524 and connector module-facing contact 528 may be at the second voltage.

As depicted, first connector module 530 may comprise two electronic device-facing contacts. Namely, an electronic device-facing contact 532 may mechanically and/or electrically connect to connector module-facing contact 522. Likewise, an electronic device-facing contact 534 may mechanically and/or electrically connect to connector module-facing contact 524.

Like first connector module 530, second connector module 540 may comprise two electronic device-facing contacts. Namely, an electronic device-facing contact 542 may mechanically and electrically connect to connector module-facing contact 526. Likewise, an electronic device-facing contact 544 may mechanically and electrically connect to connector module-facing contact 528.

Here, electronic device-facing contacts 532, 534, 542, and 544 may comprise various types of electrical contacts.

As depicted, first connector module 530 may further comprise two external connector-facing contacts. Namely, an external connector-facing contact 536 may be electrically connected to electronic device-facing contact 532. Similarly, an external connector-facing contact 538 may be electrically connected to electronic device-facing contact 534.

Like first connector module 530, second connector module 540 may also further comprise two external connector-facing contacts. Namely, an external connector-facing contact 546 may be electrically connected to electronic device-facing contact 542. Similarly, an external connector-facing contact 548 may be electrically connected to electronic device-facing contact 544.

Here, external connector-facing contacts 536, 538, 546, and 548 may comprise various types of electrical contacts.

Referring now to external connector 550, external connector 550 may comprise four electronic device module-facing contacts—i.e., an electronic device module-facing contact 552, an electronic device module-facing contact 554, an electronic device module-facing contact 551, and an electronic device module-facing contact 553.

External connector 550 may also comprise two external-facing contacts—namely an external-facing contact 556 and an external-facing contact 555. As depicted, external-facing contact 556 may be associated with the first voltage (e.g., voltage A) and external-facing contact 555 may be associated with the second voltage (e.g., voltage B).

As depicted in FIG. 5, external-facing contact 556 may be electrically connected to both of electronic device module-facing contact 552 and electronic device module-facing contact 553. Similarly, external-facing contact 555 may be electrically connected to both of electronic device module-facing contact 554 and electronic device module-facing contact 551.

As depicted in FIG. 5, in the first orientation for electronic device module 510, electronic device module-facing contact 552 is aligned with, and thus mechanically and/or electrically connected to, external connector-facing contact 536 of first connector module 530. Relatedly, electronic device module-facing contact 553 is not aligned with any external connector-facing contact of first connector module 530. Thus, in the first orientation for electronic device module 510, electronic device module-facing contact 552 provides an electrical connection between first terminal 525(a) of two-terminal circuit element 525 (associated with the first voltage, e.g., voltage A) and external-facing contact 556 (associated with the first voltage, e.g., voltage A).

As depicted in FIG. 5, in the first orientation for electronic device module 510, electronic device module-facing contact 551 is aligned with, and thus mechanically and/or electrically connected to, external connector-facing contact 538 of first connector module 530. Relatedly, electronic device module-facing contact 554 is not aligned with any external connector-facing contact of first connector module 530. Thus, in the first orientation for electronic device module 510, electronic device module-facing contact 551 provides an electrical connection between second terminal 525(b) of two-terminal circuit element 525 (associated with the second voltage, e.g., voltage B) and external-facing contact 555 (associated with the second voltage, e.g., voltage B).

However, as depicted in FIG. 6, in the second orientation for electronic device module 510 (i.e., where electronic device module 510 is rotated 180 degrees about axis 670), electronic device module-facing contact 553 is now aligned with, and thus mechanically and/or electrically connected to, external connector-facing contact 536 of first connector module 530. Relatedly, electronic device module-facing contact 552 is now not aligned with any external connector-facing contact of first connector module 530. Thus, in the second orientation for electronic device module 510, electronic device module-facing contact 553 now provides an electrical connection between first terminal 525(a) of two-terminal circuit element 525 (associated with the first voltage, e.g., voltage A) and external-facing contact 556 (associated with the first voltage, e.g., voltage A).

Relatedly, as depicted in FIG. 6, in the second orientation for electronic device module 510, electronic device module-facing contact 554 is now aligned with, and thus mechanically and/or electrically connected to, external connector-facing contact 538 of first connector module 530. Relatedly, electronic device module-facing contact 551 is now not aligned with any external connector-facing contact of first connector module 530. Thus, in the second orientation for electronic device module 500, electronic device module-facing contact 554 now provides an electrical connection between second terminal 525(b) of two-terminal circuit element 525 (associated with the second voltage, e.g., voltage B) and external-facing contact 555 (associated with the second voltage, e.g., voltage B).

Referring now to external connector 560, like external connector 550, external connector 560 may comprise four electronic device module-facing contacts—i.e., an electronic device module-facing contact 562, an electronic device module-facing contact 564, an electronic device module-facing contact 561, and an electronic device module-facing contact 563.

External connector 560 may also comprise two external-facing contacts—namely an external-facing contact 566 and an external-facing contact 565. As depicted, external-facing contact 566 may be associated with the first voltage (e.g., voltage A) and external-facing contact 565 may be associated with the second voltage (e.g., voltage B).

As depicted in FIG. 5, external-facing contact 566 may be electrically connected to both of electronic device module-facing contact 562 and electronic device module-facing contact 563. Similarly, external-facing contact 565 may be electrically connected to both of electronic device module-facing contact 564 and electronic device module-facing contact 561.

As depicted in FIG. 5, in the first orientation for electronic device module 510, electronic device module-facing contact 562 is aligned with, and thus mechanically and/or electrically connected to, external connector-facing contact 536 of first connector module 530. Relatedly, electronic device module-facing contact 563 is not aligned with any external connector-facing contact of first connector module 530. Thus, in the first orientation for electronic device module 510, electronic device module-facing contact 562 provides an electrical connection between first terminal 525(a) of two-terminal circuit element 525 (associated with the first voltage, e.g., voltage A) and external-facing contact 566 (associated with the first voltage, e.g., voltage A).

As depicted in FIG. 5, in the first orientation for electronic device module 510, electronic device module-facing contact 561 is aligned with, and thus mechanically and/or electrically connected to, external connector-facing contact 538 of first connector module 530. Relatedly, electronic device module-facing contact 564 is not aligned with any external connector-facing contact of first connector module 530. Thus, in the first orientation for electronic device module 510, electronic device module-facing contact 561 provides an electrical connection between second terminal 525(b) of two-terminal circuit element 525 (associated with the second voltage, e.g., voltage B) and external-facing contact 565 (associated with the second voltage, e.g., voltage B).

However, as depicted in FIG. 6, in the second orientation for electronic device module 510 (i.e., where electronic device module 510 is rotated 180 degrees about axis 670), electronic device module-facing contact 563 is now aligned with, and thus mechanically and/or electrically connected to, external connector-facing contact 536 of first connector module 530. Relatedly, electronic device module-facing contact 562 is now not aligned with any external connector-facing contact of first connector module 530. Thus, in the second orientation for electronic device module 510, electronic device module-facing contact 563 now provides an electrical connection between first terminal 525(a) of two-terminal circuit element 525 (associated with the first voltage, e.g., voltage A) and external-facing contact 566 (associated with the first voltage, e.g., voltage A).

Relatedly, as depicted in FIG. 6, in the second orientation for electronic device module 510, electronic device module-facing contact 564 is now aligned with, and thus mechanically and/or electrically connected to, external connector-facing contact 538 of first connector module 530. Relatedly, electronic device module-facing contact 561 is now not aligned with any external connector-facing contact of first connector module 530. Thus, in the second orientation for electronic device module 500, electronic device module-facing contact 564 now provides an electrical connection between second terminal 525(b) of two-terminal circuit element 525 (associated with the second voltage, e.g., voltage B) and external-facing contact 565 (associated with the second voltage, e.g., voltage B).

Accordingly, and as described above and depicted in FIGS. 5-6, orientation agnosticism about axis 670 can be realized due to a combination of: (1) strategic spacing/positioning of external connector-facing contacts for electronic device module 510; (2) strategic spacing/positioning of electronic device module-facing contacts for external connectors 550 and 560; and (3) strategic electrical routing through external connectors 550 and 560.

As used herein, the term module or circuit may be used describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. Various components described herein may be implemented as discrete module or described functions and features can be shared in part or in total among one or more modules. In other words, as would be apparent to one of ordinary skill in the art after reading this description, the various features and functionality described herein may be implemented in any given application. They can be implemented in one or more separate or shared modules in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where modules are implemented in whole or in part using software, these software elements can be implemented to operate with a computing or processing component capable of carrying out the functionality described with respect thereto. A processor or controller of a module might include, for example, one or more processors, controllers, control components, or other processing devices. Processors might be implemented using a general-purpose or special-purpose processing engine such as, for example, a microprocessor, controller, or other control logic. The modules might also include one or more memory components.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A module comprising:
an electronic device;
a first connector module mechanically and electrically connected to the electronic device; and
a second connector module mechanically and electrically connected to the electronic device;
wherein:
the electronic device, the first connector module, and the second connector module are arranged along a first axis with the electronic device positioned between the first connector module and the second connector module along the first axis, and
an external connector-facing interface of the first connector module is symmetric with an external connector-facing interface of the second connector module about a second axis orthogonal to the first axis.

2. The module of claim 1, wherein the external connector-facing interface of the first connector module is asymmetric about the first axis.

3. The module of claim 2, wherein:
the external connector-facing interface of the first connector module permits mechanical connection between the first connector module and an external connector in a first orientation for the module; and
the external connector-facing interface prevents mechanical connection between the first connector module and the external connector in a second orientation for the module, wherein the second orientation for the module comprises a 180 degree rotation about the first axis from the first orientation.

4. The module of claim 2, wherein the electronic device comprises:
a circuit element comprising a first terminal and a second terminal;
a first connector module-facing contact electrically connected to the first terminal,
a second connector module-facing contact electrically connected to the first terminal,
a third connector module-facing contact electrically connected to the second terminal, and
a fourth connector module-facing contact electrically connected to the second terminal.

5. The module of claim 4, wherein circuit element comprises a polarity-dependent circuit element.

6. The module of claim 5, wherein the polarity-dependent circuit element comprises a diode.

7. The module of claim 5, wherein:
the first terminal comprises an anode of the diode; and
the second terminal comprises a cathode of the diode.

8. The module of claim 1, wherein the module is configured to electrically and mechanically connect to a first external connector and a second external connector simultaneously.

9. The module of claim 8, wherein:
in a first orientation for the module, the first connector module electrically and mechanically connects to the first external connector and the second connector module electrically and mechanically connects to the second external connector; and
in a second orientation for the module rotated 180 degrees about the second axis from the first orientation for the module, the first connector module electrically and mechanically connects to the second external connector and the second connector module electrically and mechanically connects to the first external connector; and
the first and second external connectors maintain constant position and orientation between the first and second orientations for the module.

10. A module comprising:
an electronic device;
a first connector module mechanically and electrically connected to the electronic device; and
a second connector module mechanically and electrically connected to the electronic device;
wherein:
the electronic device, the first connector module, and the second connector module are arranged along a first axis with the electronic device positioned between the first connector module and the second connector module along the first axis,
an external connector-facing interface of the first connector module is symmetric with an external connector-facing interface of the second connector module about a second axis orthogonal to the first axis,
the external connector-facing interface of the first connector module is asymmetric about the first axis, and
the external connector-facing interface of the second connector module is asymmetric about the first axis.

11. The module of claim 10, wherein:
the external connector-facing interface of the first connector module permits mechanical connection between the first connector module and an external connector in a first orientation for the module; and
the external connector-facing interface prevents mechanical connection between the first connector module and the external connector in a second orientation for the module, wherein the second orientation for the module comprises a 180 degree rotation about the first axis from the first orientation.

12. The module of claim 10, wherein the electronic device comprises:
a circuit element comprising a first terminal and a second terminal;
a first connector module-facing contact electrically connected to the first terminal,
a second connector module-facing contact electrically connected to the first terminal,
a third connector module-facing contact electrically connected to the second terminal, and
a fourth connector module-facing contact electrically connected to the second terminal.

13. The module of claim 10, wherein circuit element comprises a polarity-dependent circuit element.

14. The module of claim 13, wherein the polarity-dependent circuit element comprises a diode.

15. The module of claim 14, wherein:
the first terminal comprises an anode of the diode; and
the second terminal comprises a cathode of the diode.

16. The module of claim 11, wherein the module is configured to electrically and mechanically connect to a first external connector and a second external connector simultaneously.

17. The module of claim 16, wherein:
in a first orientation for the module, the first connector module electrically and mechanically connects to the first external connector and the second connector module electrically and mechanically connects to the second external connector; and
in a second orientation for the module rotated 180 degrees about the second axis from the first orientation for the module, the first connector module electrically and mechanically connects to the second external connector and the second connector module electrically and mechanically connects to the first external connector; and
the first and second external connectors maintain constant position and orientation between the first and second orientations for the module.

18. A system comprising:
an electronic device module comprising:
an electronic device comprising:
a circuit element comprising a first terminal and a second terminal;
a first connector module-facing contact electrically connected to the first terminal, and
a second connector module-facing contact electrically connected to the second terminal,
a connector module comprising:
a first electronic device-facing contact electrically and mechanically connected to the first connector module-facing contact of the electronic device,
a first external connector-facing contact electrically connected to the first electronic device-facing contact,
a second electronic device-facing contact electrically and mechanically connected to the second connector module-facing contact of the electronic device, and
a second external connector-facing contact electrically connected to the second electronic device-facing contact; and
an external connector comprising:
a first electronic device module-facing contact,
a second electronic device module-facing contact,
a third electronic device module-facing contact,
a fourth electronic device module-facing contact,
a first external-facing contact electrically connected to the first electronic device module-facing contact and the second electronic device module-facing contact, and
a second external-facing contact electrically connected to the third electronic device module-facing contact and the fourth electronic device module-facing contact;
wherein in a first orientation for the electronic device module:
the first electronic device module-facing contact is configured to align with, and mechanically and electrically connect with the first external connector-facing contact of the connector module, and
the third electronic device module-facing contact is configured to align with, and mechanically and electrically connect with the second external connector-facing contact of the connector module; and
wherein in a second orientation for the electronic device module rotated 180 degrees from the first orientation:
the second electronic device module-facing contact is configured to align with, and mechanically and electrically connect with the first external connector-facing contact of the connector module, and
the fourth electronic device module-facing contact is configured to align with, and mechanically and electrically connect with the second external connector-facing contact of the connector module.

19. The system of claim 18, wherein
the electronic device, the connector module, and the external connector are arranged along an axis such that the connector module is positioned between the electronic device and the external connector along the axis; and
in the second orientation for the electronic device module, the electronic device is rotated 180 degrees about the axis from the first orientation.

20. The system of claim 19, wherein the circuit element comprises diode.
